(19) United States
(12) Patent Application Publication
(10) Pub. No.: US 2003/0195785 A1
(43) Pub. Date: Oct. 16, 2003

(54) Token based control flow for workflow

(75) Inventors: Abdulla Sarfraz Thalangara, Kerala (IN); Ashwin Kumar, Hiriadka (IN); Lakshman Nagisetty, Andhra Pradesh (IN)

Correspondence Address: HONEYWELL INTERNATIONAL INC., 101 COLUMBIA ROAD, P O BOX 2245, MORRISTOWN, NJ, 07962-2245, US

(73) Assignee: Honeywell Inc.

(21) Appl. No.: 10/123,825

(22) Filed: Apr. 15, 2002

(51) Int. Cl. G06F 17/60

(52) U.S. Cl. 705/8

(57) ABSTRACT

A workflow management system utilizes tokens associated with work flowing through paths of activities or tasks under control of constructs. The token is representative of the path taken to reach the current activity. Tokens are given attributes for activities and constructs, such as token value and construct IDs. Rules are defined for activities and constructs to use when receiving, modifying and passing on the tokens. The rules in one embodiment comprise algorithms for comparing tokens, consuming tokens, appending tokens, and generating tokens. The tokens provide the ability to control flow of the work, such as sequencing, paralleling, iterating and synchronizing activities.

### FIELD OF THE INVENTION

The present invention relates to workflow, and in particular to token based control flow for workflow.

### BACKGROUND OF THE INVENTION

Workflow systems are used for modeling business processes, business to business interaction and business coordination. There are now large numbers of commercially available workflow management systems (WFMS) and Business process integrators (BPI). A typical example of workflow is that of approving a paper in an academic setting. Approval of the paper represents work to be done. Sometimes approval by more than one professor is required. Both internal and external reviews might be required, and review by a legal department for inventions may also be required. The approvals are referred to as activities or tasks, and the control of the order of execution of the activities is performed is referred to as a control-flow perspective.

The control-flow perspective of workflow concentrates on how to execute the activities and when to execute what activity. It mainly deals with sequencing, paralleling, iterating and synchronizing the activity execution. Data perspective deals about how the data flows from one task to another and what data is passed from one task to another task. Typical data flowing includes business documents and local variables of the workflow (workflow relevant data). The operational perspective deals with the actions associated with individual tasks and operating on actions. An action can be a database call to retrieve some data or it can be call on a component method etc.

Control flow is an essential building block of workflow engines. The control flow perspective is important to the success of a workflow management system product. As discussed above the control flow is essentially routing of tasks. The routing can be Sequential routing, parallel routing, conditional routing and iterative routing. A sequential routing routes the tasks one after another in a sequential manner. Parallel routing in the workflow context executes more than one task simultaneously. Usually interdependent tasks will get executed sequentially and independent tasks will get executed parallel.

Sometimes a set of tasks needs to be executed iteratively, this type of executing of tasks is called iterative routing. Sometimes execution of a task depends on the result of a condition, this type of task execution is called conditional routing. Sometimes iterative routing can depend on one or more conditions. Based on a condition, a set of tasks might get executed iteratively.

Almost every workflow product addresses the above routing concepts. Typically they use constructs such as splits and join to achieve the routing concepts. However there can be variations in their usage.

Splits are used for selective execution of tasks or for parallelism in the task execution. Splits can be of two kinds. A split will have one input and multiple outputs. If a split is thought of as a node in a graph then an in-degree of split is one and an out-degree can be any number greater than one.

An unconditional split does not contain any condition associated with it. Workflow engines interpret this construct to achieve parallelism. Whenever workflow control reaches this split, workflow engine executes activities associated with the split simultaneously. Usually independent activities are executed simultaneously. To achieve selective (conditional) routing a WFMS uses a conditional split. This split is associated with a condition. The workflow engine evaluates the condition associated with the construct. Based on the evaluation of the condition it will make a decision regarding execution of a particular activity.

Joins are used to synchronize activities that are executing. Using the nodes in the graph analogy, the join in-degree is more than one and the out-degree is one. It has multiple inputs and only one output similar to multiplexer. Based on synchronization needs joins are classified into four categories, AND joins, OR joins, partial joins and discriminative joins. An AND join is used to synchronize all the incoming activities, while OR joins wait for only one incoming activity to occur. A partial join waits for a predetermined number of incoming activities to occur, and a discriminative join waits for a condition, such as completion of incoming activities to become true.

Some times a set of tasks needs to be executed iteratively, this type of executing of tasks is called iterative routing. Some times executing of a task might depend on the result of a condition; this type of executing a task is called conditional routing. Sometimes iterative routing can depend on condition. Based on a condition a set of tasks might get executed iteratively.

An increase in the complexities of business and other processes has lead to more complex constructs required to model the resulting workflow. These constructs introduce a number of complexities that current workflow engines do not handle well; resulting in activities needlessly being performed more than once, and other activities incorrectly being blocked from being performed.

### SUMMARY OF THE INVENTION

A workflow system utilizes tokens associated with work flowing through paths of activities or tasks under control of constructs. The token is representative of the path taken to reach the current activity. Tokens are given attributes for activities and constructs, such as token value and construct IDs. Rules are defined for activities and constructs to use when receiving, modifying and passing on the tokens.

The rules in one embodiment comprise algorithms for comparing tokens, consuming tokens, appending tokens, and generating tokens. The tokens provide the ability to control flow of the work, such as sequencing, paralleling, iterating and synchronizing activities.

The algorithms identify the role of split, activity and join in routing. With the token, the state of a process is identifiable at a given point of time. Also the join construct is able to synchronize the different flows successfully.

### BRIEF DESCRIPTION OF THE DRAWINGS

FIG. 1 is a flow diagram illustrating a split.

FIG. 2 is a flow diagram illustrating an unconditional split.

FIG. 3 is a flow diagram illustrating a conditional split.

FIG. 4 is a flow diagram illustrating a join.

FIG. 5 is a flow diagram illustrating an AND join.

FIG. 6 is a flow diagram illustrating an OR join.

FIG. 7 is a flow diagram illustrating a partial join.

FIG. 8 is a flow diagram illustrating a conditional join.

FIG. 9 is a flow diagram illustrating a loopback join.

FIG. 10 is a flow diagram illustrating a workflow for approval of a paper by three professors.

FIG. 11 is a flow diagram illustrating a workflow for approval of a paper by one of three professors.

FIG. 12 is a flow diagram illustrating a workflow for approval of a paper by one of three professors with two rounds of approval required.

FIG. 13 is a block diagram of a computer system implementing a workflow engine for executing the current invention.

FIG. 14 is a flow diagram of a test case illustrating token management during performance of work.

FIG. 15 is a flow diagram of an alternative test case illustrating token management during performance of work.

### DETAILED DESCRIPTION OF THE INVENTION

In the following description and the drawings illustrate specific embodiments of the invention sufficiently to enable those skilled in the art to practice it. Other embodiments may incorporate structural, logical, electrical, process, and other changes. Examples merely typify possible variations. Individual components and functions are optional unless explicitly required, and the sequence of operations may vary. Portions and features of some embodiments may be included in or substituted for those of others. The scope of the invention encompasses the full ambit of the claims and all available equivalents. The following description is, therefore, not to be taken in a limited sense, and the scope of the present invention is defined by the appended claims.

The functions described herein are implemented in software in one embodiment, where the software comprises computer executable instructions stored on computer readable media such as memory or other type of storage devices. The term “computer readable media” is also used to represent carrier waves on which the software is transmitted. Further, such functions correspond to modules, which are software, hardware, firmware or any combination thereof. Multiple functions are performed in one or more modules as desired, and the embodiments described are merely examples.

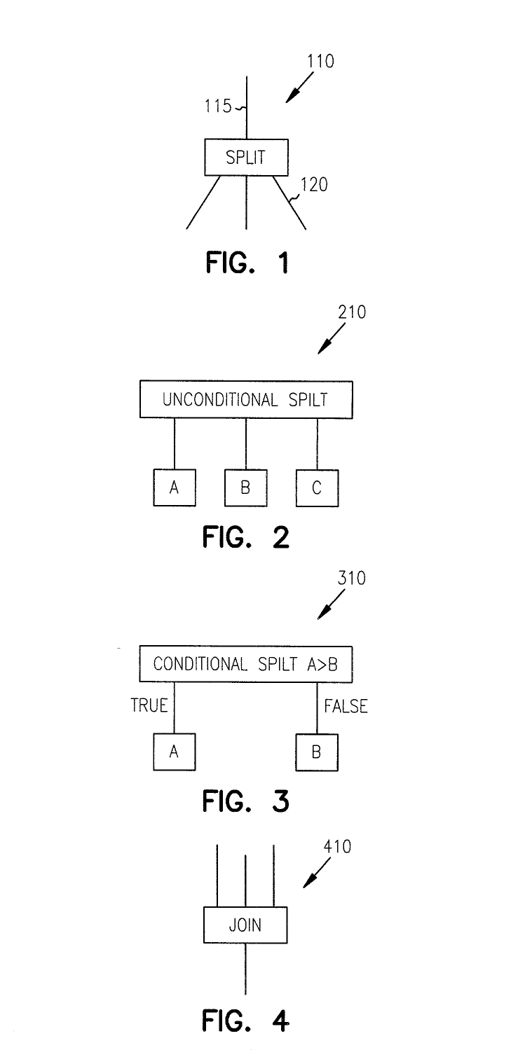

The detailed description is divided into several parts. A first part describes constructs such as splits and joins, and the variations of them. FIGS. 1-12 illustrate both known constructs, and are also used to represent the token flow management in accordance with the present invention. A second part describes tokens, and rules used at various constructs to utilize the tokens to control flow and identify the path of work. An algorithm that is implemented on a computer system in the form of a computer program is then described, followed by examples showing workflow paths and the state of the tokens at each node in the path.

A split construct is represented in block form in FIG. 1 at 110. The usage of splits is for selective execution of tasks or for parallelism in the task execution. Splits can of two kinds. A split will have one input 115 and multiple outputs 120. If you think split as node in the graph then the in-degree of split is one and out-degree can be any number greater than one.

An unconditional split construct is represented in block form in FIG. 2 at 210. This split doesn't contain any condition associated with it. Workflow engines interpret this construct to achieve parallelism. Whenever the control reaches this split workflow engine will execute the Activities associated with this split simultaneously. Usually independent activities are executed simultaneously. E.g.: Execute TASKS A, B, C.

A conditional split is represented in block form in FIG. 3 at 310. To achieve selective (conditional) routing WFMS use conditional split. This split is associated with the condition. Workflow engine when it encounters this construct evaluates the condition associated with it. Based on the evaluation of the condition it will take a decision of executing a particular Activity. E.g.: If (a>b) then execute Activity A Else execute Activity B. Conditon (a>b) is treated as a conditional split. On the result of the condition a>b if it is true then Activity A will be executed otherwise (else) Activity B will be executed.

A join construct is represented in block form in FIG. 4 at 410. Joins are used for synchronizing the activities that are executing. If analogized to a graph, the join in-degree is more than one and out-degree is one. It has multiple inputs and only one output similar to multiplexer.

Based on synchronization needs joins are classified into four categories. An attribute called cardinality is used to achieve synchrnonization.

Cardinality of a join will tell the workflow engine the number of incoming activities to synchronize. If cardinality is one then the workflow engine will wait until any one of the incoming activities gets completed.

When join is used to synchronize all the incoming activities then it is called AND Join, represented at 510 in FIG. 5. If the join has two inputs coming and your business process needs that the successive activity can only start after the completion of two incoming activities then you can use AND join to do that. Here the cardinality of join will become 2. Activity C will get executed only after completion of both the activities A and B.

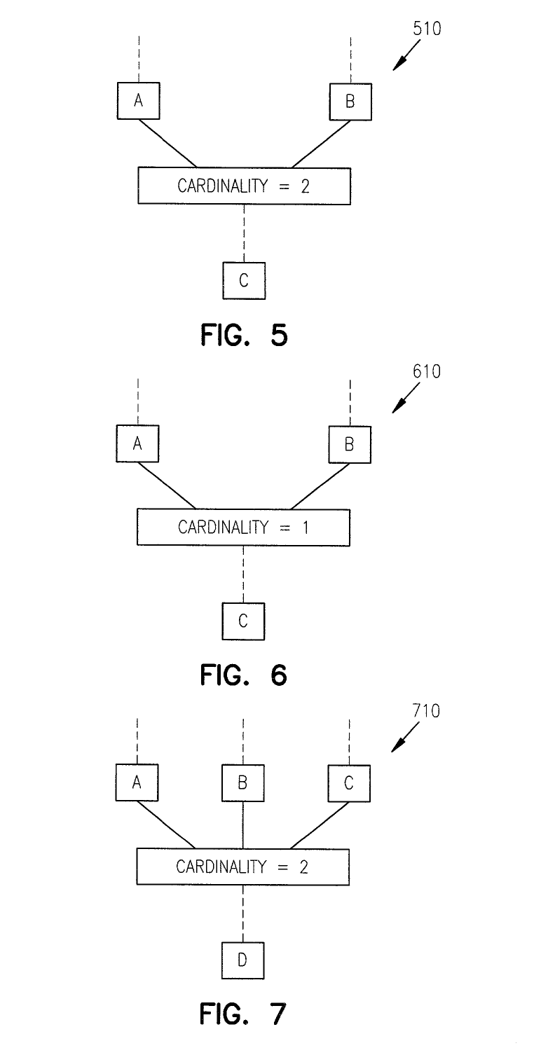

An OR join indicated at 610 in FIG. 6 has a cardinality attribute of one. This tells the workflow engine if any one of the incoming activities gets completed then the successive activity can carry on. FIG. 6 illustrates a situation where activity C can start if any one of the incoming activities A and B gets completed.

A partial join indicated at 710 in FIG. 7 has a cardinality attribute of more than one but less than the incoming number of activities. This tells the workflow engine not to execute the activity succeeding join until the number of activities specified in cardinality attribute of join gets completed. In a situation where the incoming activities of join are A, B and C. Activity D should start only after the execution if any two of the incoming activities gets completed.

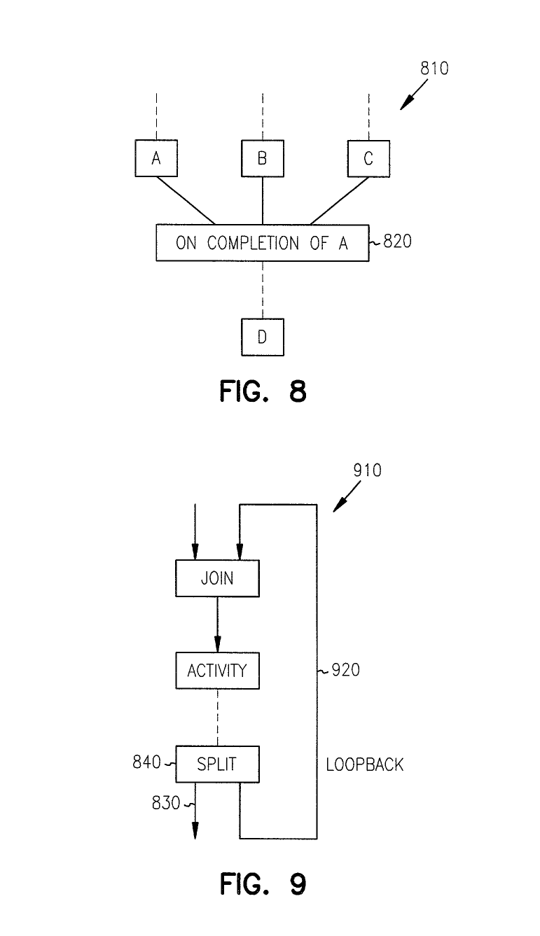

A discriminative join illustrated in FIG. 8 at 810 uses an attribute called condition 820. The condition 820 which is an attribute of join is satisfied exclusively on completion of activities. Usually workflow activity has a state. During execution, an activity changes its state from waiting to ready, ready to executing, and executing to completion. These are the most common states of the activity. Other states may occur in different workflow processes.

A discriminative join does not contain attribute cardinality. It has only one attribute called condition. For example, if a process needs that an activity(D) can execute only after a specific incoming activity gets completed out of n number of incoming activities.

All other types of joins can be represented using the condition attribute of join, but doing so requires a condition on ‘n’ number of incoming activities. This becomes complex and costly during process execution evaluation of the condition.

Sometimes a set of activities needs to be executed iteratively based on a condition. This condition usually will be on the workflow relevant data or business process data. Splits and joins are used to achieve the iteration. A typical iterative construct illustrated at 910 in FIG. 9 has a join with inputs. One of the inputs is a loopback path 920 and the other will be direct path 930. The loopback path 920 usually comes from a split 940.

Having discussed about the different constructs in defining the business process implementation difficulties of the use of these constructs to handle workflow processes are described. In one example where the process is a technical paper review where the paper should be reviewed by all available professors. In this example, the number of professors are three, A, B and C, and the paper is submitted to all three professors at the same time.

The above process is composed of the following activities:

1) Paper submission—This event starts or triggers the process. The event is referred to as START Activity

2) Professor A's review where professor with name A reviewing paper. We name this as PROFA

3) Professor B's review where professor with name B reviewing paper. We name this as PROFB

4) Professor C's review where professor with name C reviewing paper. We name this as PROFC

5) END where paper gets reviewed. We name this as END

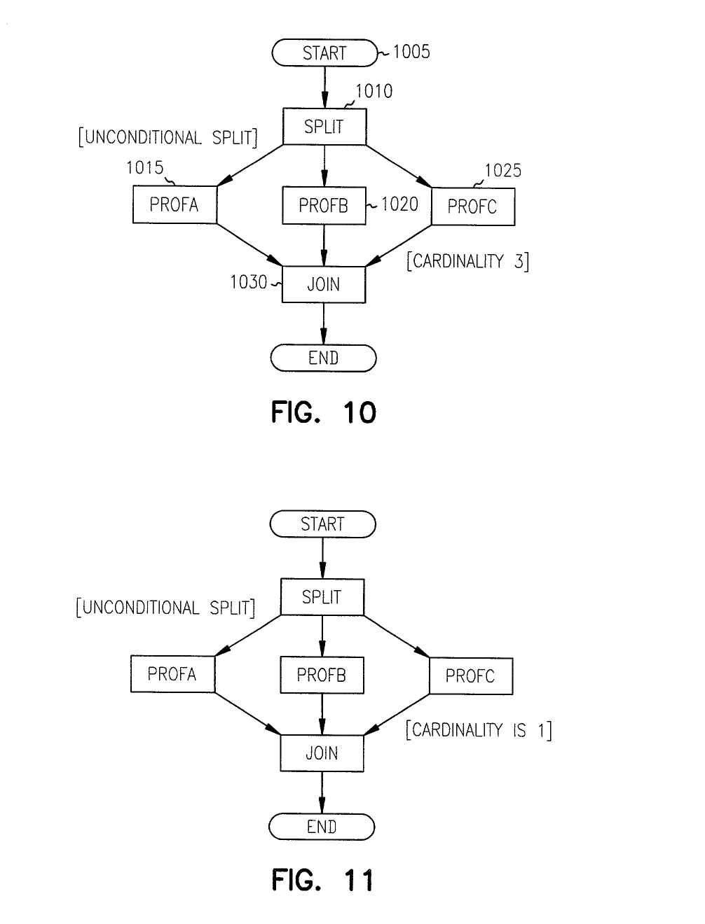

The process is illustrated in FIG. 10 using the above constructs split and join. Once the process starts 1005 (i.e., the paper gets submitted), workflow splits 1010 the flow into three activities (PROFA 1015, PROFB 1020, PROFC 1025) providing them each a copy of the submitted paper. Once any activity completes, the workflow engine will trigger the next activity ie after the completion of activity PROFA workflow engine will trigger a join construct 1030. At at this point the workflow engine finds the cardinality is 3, since approval of all professors is required, and waits for other activities to get completed. Similarly When PROFB gets completed workflow engine will trigger the join 1030 and using the cardinality finds that workflow should wait further. Only when the number of completed activities are equal to the cardinality an activity end 940 is executed or the process stops.

A second scenario slightly changes the process. If any of the activities are completed, i.e., any one professor reviews the paper the process is completed as illustrated in FIG. 11. The cardinality is originally set to one, so the activity END executes when PROFA finishes the review activity. If after some time PROFB completes the paper review the Activity END is again triggered. This is undesired behavior. To remove this behavior, the join can only get executed once.

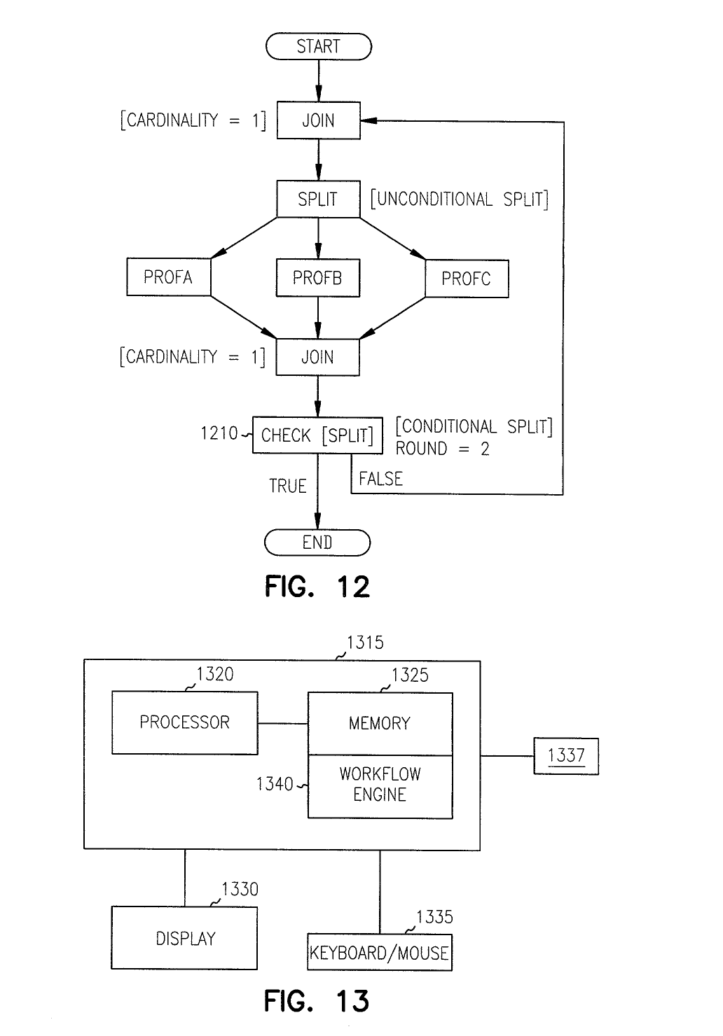

The process definition is further changed in the next example by introdocuing one more activity called CHECK 210 as seen in FIG. 12. The process now is defined to ensure that the paper should go for review for 2 rounds minimum and in each round if any one professor accepts it, it will go for next round. After the secound round the paper is accepted. The activity CHECK 210 in this example is nothing but a split construct that checks the review round. With the above assumption that join can only execute once, there is a problem. Once any professor reviews and approves in the first round, it takes a false path and again goes and submits the paper for the second round. When any professor in the second round approves the workflow engine will try to execute the join. Since it is already executed once it won't.

This pattern, i.e., the combination of unconditional split and OR join (cardinality=1) along with iteration has an implementation difficulty that is addressed by the use of a token. Tokens comprises a string of attributes that represent the state of the work as it progresses through the activities associated with the work. In cases where work is split, each portion of the work has an associated token. Constructs create, modify and combine tokens while work is progressing. Tokens flowing in the system represent the path taken to reach the current activity. Tokens also provide an audit trail in one embodiment.

Several conventions are used for tokens corresponding to activities and constructs. Those conventions are first described, followed by a description of the rules regarding creation, modification and combining of the tokens.

Activities use one attribute of tokens, a token value, to store the token value used previously. Initially, the token value, TokenValue=0.

The join construct uses two attributes of the tokens, TokenValue, to store the token value used previously, and TokenStringPassed, to store the token string that is sent. Initially TokenValue=0 and TokenStringPassed=“”.

The split construct uses one attribute, TokenValue, to store the token value used previously. Initially TokenValue=0. The split and join constructs have unique ids associated with them. Join is a producer of tokens, and also a consumer. Activities are carriers of tokens. Splits also are carriers of tokens. Further, the workflow engine is able to find out whether a token is from a loopback edge, or a non loopback edge.

Join constructs are capable of remember tokens it has allowed and is capable of generating a token. The generated token will have a value of one more than the previously generated token. Joins are also capable of consuming tokens as described in the rules outlined below. Initially, a token allowed and token generated values are zero.

Split constructs are capable of remember the last token it generated. Initially the value of the token is zero, and tokens generated have a value of one more than the last generated token incremented than one.

Activities remember the last token generated, and initially generate tokens with value of zero. Generated tokens have a value of the last generated token incremented by one.

Each token has a structure comprising two attributes, token value, and id of the split or join. Token values and ids are separated by a delimiter, such as a “:”, or any other symbol desired. A combination of a token value and id is referred to as an atomic token. Different atomic tokens are separated a delimiter such as “|”. Notation used for tokens include LCToken: Last Consumed Token, GenToken: Generated Token ie LCToken+1 E.g. for a split or activity node with identifier ‘id’ and LCToken as a: id1|b:id then LCToken+1 is “b+1:id” represented as GenToken(LCToken+1). InTokens are nothing but incoming tokens.

TokenValue—to store the token value used previously.

TokenStringPassed—to store the token string that is sent.

TokenStringReceived—Incoming token

In one embodiment, several rules are used for handling tokens. a first rule of dealing with tokens includes comparison of two InTokens (incoming tokens) and finding the maximum is as follows

Rule.1.1: Comparing two InTokens and finding a maximum token value

1) Take a sub string from both the tokens, such that all the ids of both the InTokens are equal.

E.g. InToken1 is a:id1|b:id2

InToken2 is c:id1|d:id2|e:id3

Then for comparing take two InTokens as a:id1|b:id2| and c:id1|d:id2

2) The resultant tokens are compared such that the individual atomic tokens are compared sequentially. Once the greatest atomic token is found, the respective InToken is modified to be the maximum among them.

E.g. InToken1 a:id1|b:id2

InToken2 c:id1|d:id2

Then a is compared with c

If a>c then InToken1 is maximum

If a<c then InToken2 is maximum

If a=c then b is compared similarly with d

If a =c and b=d then arbitrary choice is made.

Note: This is denoted as MAXIMUM (InToken1 . . . InTokenn)

Rule.1.2: Consumption of two tokens is as follows

1) From the InToken find the atomic token with the same Id

E.g. InToken a:id1|b:id2|c:id3 and the Join id is id2

2) Out Going Token is the token until the atomic token with the same id

E.g. InToken a:id1|b:id2|c:id3 and the Join id is id2

Note: It is denoted as CONSUME (a:id1|b:id2|c:id3, id2)=a:id1|b+1:id2

Rule.1.3: Appending of two tokens is as follows

1) Generate the atomic token with GenToken associated with Id

E.g. Suppose GenToken is g and id of Split/Activityobject is Id then the atomic token will be g:Id.

2) Append the generated atomic token with the InToken

E.g. Suppose InToken is a:id1|b:id2 and generated atomic token is g:Id, Then the APPEND (a:id1|b:id2|, g:Id)=a:id1|Ib:id21g:Id

Note: It is denoted as APPEND (a:id1|b:id2, g:Id)=a:id1|b:id2|g:Id

Rule.2: If the incoming token is from a non-loop back edge, then

Rule 2.a (for JOIN):

Incoming Token: nothing

Last Consumed Token: 0

Generated Token: 1, that is Last Consumed Token +1 3

Outgoing Token: 1:id using Rule 1.3

Rule 2.b (for JOIN):

Incoming Token: Token strings (InToken)

Last Consumed Token: LCToken

Generated Token: GenToken (LCToken +1)

Outgoing Token: APPEND(MAXIMUM (InToken, LCToken) using Rule 1.1, GenToken) using Rule 1.3.

Rule 2.c (for Join):

Incoming Token: if there are n number of incoming tokens then the maximum of them according to Rule 1.1 is taken

MAXIMUM ((InToken1 . . . InTokenn)

Last Consumed Token: LCToken

Generated Token: GenToken (LCToken +1)

Outgoing Token: Similar as rule 2.2 that is APPEND(MAXIMUM (MAXIMUM (InToken1 . . . InTokenn), LCToken),GenToken)

Rule.3 (for Join): If the incoming token is from a loop back edge, then

Incoming Token: InToken

Last Consumed Token: LCToken

Generated Token: GenToken (LCToken +1)

Outgoing Token: CONSUME (Maximum(InToken, LcToken), using Rule 1.2, id)

Rule.4 (for Split and Activity):

Incoming Token: InToken

Last Consumed Token: LCToken

Generated Token: GenToken (LCToken +1)

Outgoing Token: APPEND (InToken, GenToken) using Rule 1.3

The following algorithm contains functions implemented in computer programming code executed on a computer system in one embodiment. In further embodiments, hardware, firmware or software, or combinations of the same are used to implement the algorithm. The algorithm is represented in a pseudocode listing, which is easily used by one skilled in the art to program a workflow engine:

Flow(TokenStringReceived)
Begin
Step.1:

If the receiving node is of type Activity, then
begin

TokenValue = TokenValue + 1

TokenString = TokenStringReceived + “|” +
TokenValue + “:” + id
Send the TokenString.

end

Step.2:

Else if the receiving node is of type Split, then
Begin

TokenValue = TokenValue + 1
TokenString = TokenStringReceived + “|” +
TokenValue + “:” + id
Send the TokenString.

End

Step.3:

Else if the receiving node is of type Join, then
Begin

If the incoming edge is a non-loop back edge, then
Begin

If TokenStringPassed = “”, then
Begin

TokenValue = TokenValue + 1
TokenStringPassed = TokenStringReceived + “|” +

TokenValue + “:” + id

Send TokenStringPassed.

end
Else
Begin

TokenSubString = Take the leftmost substring of the
TokenStringReceived upto the point where both
TokenStringReceived and TokenStringPassed have the
same identifiers.
If TokenSubString is greater than TokenStringPassed,
then
Begin

TokenValue = TokenValue + 1
TokenStringPassed = TokenSubString + “|” +

TokenValue + “:” + id.

Send TokenStringPassed.

End
Else

Block the TokenString.

end

end
else if the incoming token string is from a loop back edge, then
begin

TokenSubString = Take a substring from the

TokenStringReceived skipping the characters from the
point where the identifier of the current join is present.

If TokenSubString = TokenStringReceived, then
Begin

// It implies that the current join-id is not in
TokenStringReceived.
In the TokenStringReceived, increment the TokenValue of
last token.
TokenValue = TokenValue + 1
TokenStringPassed = TokenSubString + “|” +

TokenValue + “:” + id

Send the TokenStringPassed

end
Else if TokenSubString is greater than TokenStringPassed,

then TokenValue = TokenValue + 1
TokenStringPassed = TokenSubString + “|” +

TokenValue + “:” + id

Send the TokenStringPassed

Else

Block the Token String

End

end

end.

The above algorithm identifies the role of split, activity and join in routing. With the token the state of a process is identifiable at a given point of time. Also join is able to synchronize the different flows successfully. Using this token management synchronization, identifying the state of a process becomes easy.

A block diagram of a workflow system is indicated generally at 1210 in FIG. 12. The workflow system comprises a computer system 2115 having a processor 2120, memory 2125, and input/output capabilities, such as a monitor 2130, keyboard/mouse 2135 and other input devices from which the completion of activities are input, such as wands, scanners, and other input devices. A workflow engine 2140 is stored in memory 2125 for execution on processor 2120. The workflow engine executes the above algorithm. The workflow engine comprises one or more modules of software that implement the functions of the algorithm and the rules for token management.

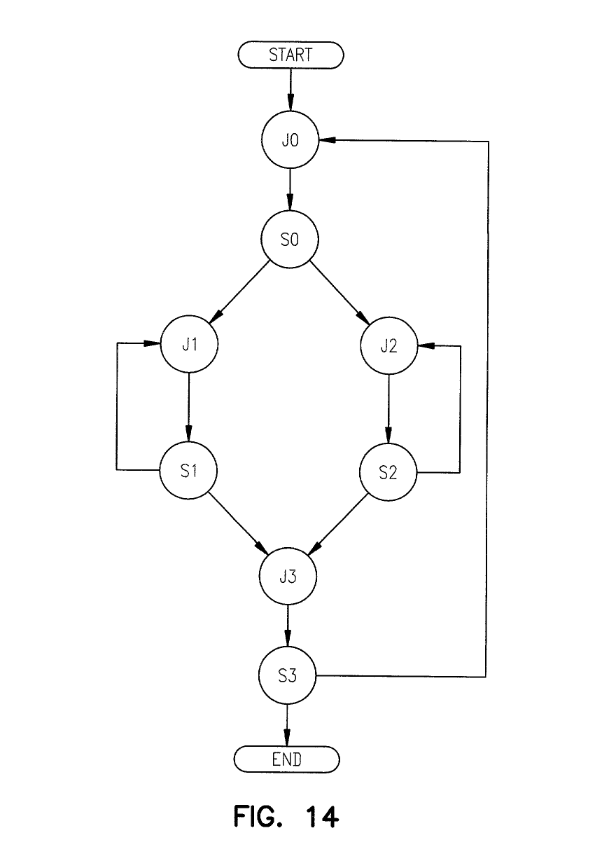

A first example of a process is shown in FIG. 14. FIG. 14 shows multiple nodes in a process defined with splits, labeled Sn, and joins, labeled Jn. Several iterations are included in this example. Token management by a workflow engine is illustrated for this example in the following table, Table 1. The table shows incoming and outgoing or passed tokens from each node, in addition to creation, modification and consumption of the tokens in accordance with the previous rules described.

TABLE 1
From Start to J0
Consumed Token = null
Token passed from J0 = 1:J0|[using Rule 2.a.]
From J0 to S0
Incoming Tokens = 1:J0|
Token passed from S0 = 1:J0|1:S0|[using Rule 4.]

| | |
|---|---|
| From S0 to J1 | From S0 to J2 |
| Incoming Tokens = 1:J0\|1:S0\| | Incoming Tokens = 1:J0\|1:S0\| |
| Consumed Token = null | Consumed Token = null |
| Token passed from J1 = 1:J0\|1:S0\|1:J1\| | Token passed from J2 = 1:J0\|1:S0\|1:J2\| |
| [using Rule 2.b.] | [using Rule 2.b.] |
| From J1 to S1 | From J2 to S2 |
| Incoming Token = 1:J0\|1:S0\|1:J1\| | Incoming Token = 1:J0\|1:S0\|1:J2\| |
| Token Passed from S1 = 1:J0\|1:S0\|1:J1\|1:S1\| | Token Passed from S2 = 1:J0\|1:S0\|1:J2\|1:S2\| |
| [using Rule 4.] | [using Rule 4.] |
| From S1 to J1 | From S2 to J2 |
| Incoming Tokens = 1:J0\|1:S0\|1:J1\|1:S1\| | Incoming Tokens = 1:J0\|1:S0\|1:J2\|1:S2\| |
| Consumed Token = 1:J0\|1:S0\|1:J1\| | Consumed Token = 1:J0\|1:S0\|1:J2\| |
| Token passed from J1 = 1:J0\|1:S0\|2:J1\| | Token passed from J2 = 1:J0\|1:S0\|2:J2\| |
| [using Rule 3.] | [using Rule 3.] |
| From J1 to S1 | From J2 to S2 |
| Incoming Token = 1:J0\|1:S0\|2:J1\| | Incoming Token = 1:J0\|1:S0\|2:J2\| |
| Token Passed from S1 = 1:J0\|1:S0\|2:J1\|2:S1\| | Token Passed from S2 = 1:J0\|1:S0\|2:J2\|2:S2\| |
| [using Rule 4.] | [using Rule 4.] |

From S1 to J2, S2 to J3

| | |
|---|---|
| Incoming Tokens: | 1:J0\|1:S0\|2:J1\|2:S1\| |
| | 1:J0\|1:S0\|2:J2\|2:S2\| |

Consumed Token: null
Token passed from J3 = 1:J0|1:S0|2:J1|2:S1|1:J3|[using Rule 2.a.]
From J3 to S3
Incoming Token = 1:J0|1:S0|2:J1|2:S1|1:J3|
Token Passed from S3 = 1:J0|1:S0|2:J1|2:S1|1:J3|1:S3
[using Rule 4.]
From S3 to J0
Incoming Tokens = 1:J0|1:S0|2:J1|2:S1|1:J3|1:S3|
Consumed Token = 1:J0|
Token passed from J0 = 2:J0|
[using Rule 3.]
From J0 to S0
Incoming Tokens = 2:J0|
Token passed from S0 = 2:J0|2:S0|[using Rule 4.]

| | |
|---|---|
| From S0 to J1 | From S0 to J2 |
| Incoming Tokens = 2:J0\|2:S0\| | Incoming Tokens = 2:J0\|2:S0\| |
| Consumed Token = 1:J0\|1:S0\|2:J1\| | Consumed Token = 1:J0\|1:S0\|2:J2\| |
| Token passed from J1 = 2:J0\|2:S0\|3:J1\| | Token passed from J2 = 2:J0\|2:S0\|3:J2\| |
| [using Rule 2.b.] | [using Rule 2.b.] |
| From J1 to S1 | From J2 to S2 |
| Incoming Token = 2:J0\|2:S0\|3:J1\| | Incoming Token = 2:J0\|2:S0\|3:J2\| |
| Token Passed from S1 = 2:J0\|2:S0\|3:J1\|3:S1\| | Token Passed from S2 = 2:J0\|2:S0\|3:J2\|3:S2\| |
| [using Rule 4.] | [using Rule 4.] |
| From S1 to J1 | From S2 to J2 |
| Incoming Tokens = 2:J0\|2:S0\|3:J1\|3:S1\| | Incoming Tokens = 2:J0\|2:S0\|3:J2\|3:S2\| |
| Consumed Token = 2:J0\|2:S0\|3:J1\| | Consumed Token = 2:J0\|2:S0\|3:J2\| |
| Token passed from J1 = 2:J0\|2:S0\|4:J1\| | Token passed from J2 = 2:J0\|2:S0\|4:J2\| |
| [using Rule 3.] | [using Rule 3.] |
| From J1 to S1 | From J2 to S2 |
| Incoming Token = 2:J0\|2:S0\|4:J1\| | Incoming Token = 2:J0\|2:S0\|4:J2\| |
| Token Passed from S1 = 2:J0\|2:S0\|4:J1\|4:S1\| | Token Passed from S2 = 2:J0\|2:S0\|4:J2\|4:S2\| |
| [using Rule 4.] | [using Rule 4.] |
| From S1 to J3, S2 to J3 | |

| | |
|---|---|
| Incoming Tokens: | 2:J0\|2:S0\|4:J1\|4:S1\| |
| | 2:J0\|2:S0\|4:J2\|4:S2\| |

Consumed Token: 1:J0|1:S0|2:J1|2:S1|1:J3|
Token passed from J3 = 2:J0|2:S0|4:J1|4:S1|2:J3|[using Rule 2.c.]
From J3 to S3
Incoming Token = 2:J0|2:S0|4:J1|4:S1|2:J3|
Token Passed from S3 = 2:J0|2:S0|4:J1|4:S1|2:J3|2:S3|
[using Rule 4.]
From S3 to END
FLOW IS TERMINATED

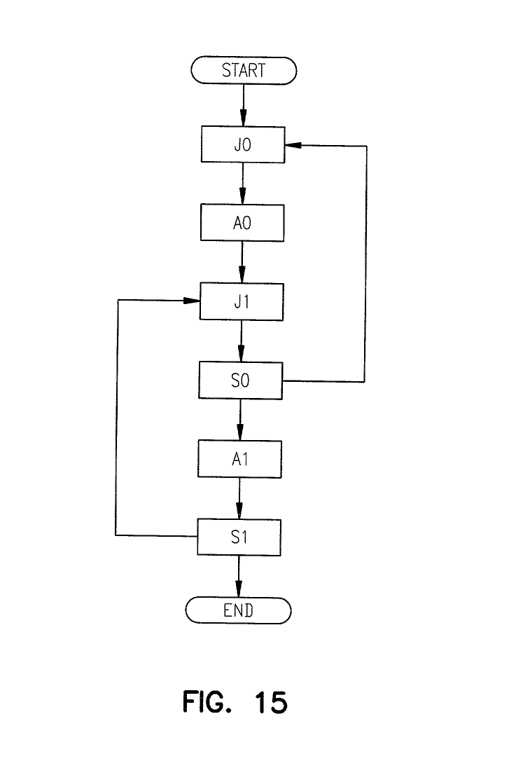

A second example of a process is shown in FIG. 15. FIG. 15 shows multiple nodes in a process defined with splits, labeled Sn, and joins, labeled Jn. Activities are included in the second example and are labeled An. Several iterations are included in this example. Token management by a workflow engine is illustrated for this example in the following table, Table 2. The table shows incoming and outgoing or passed tokens from each node, in addition to creation, modification and consumption of the tokens in accordance with the previous rules described.

TABLE 2
From Start to J0
Consumed Token = null
Token passed from J0 = 1:J0|[using Rule 2.a.]
From J0 to A0
Incoming Token = 1:J0|
Token Passed from A0 = 1:J0|1:A0|[using Rule 4]
From A0 to J1
Incoming Token = 1:J0|1:A0|
Consumed Token = null
Token passed from J1 = 1:J0|1:A0|1:J1|[using Rule 2.a.]
From J1 to S0
Incoming Token = 1:J0|1:A0|1:J1|
Token passed from S0 = 1:J0|1:A0|1:J1|1:S0|[using Rule 4]
From S0 to J0
Incoming Token = 1:J0|1:A0|1:J1|1:S0|
Consumed Token = 1:J0|
Token Passed from J0 = 2:J0|[using Rule 3]
From J0 to A0
Incoming Token = 2:J0|
Token Passed from A0 = 2:J0|2:A0|[using Rule 4]
From A0 to J1
Incoming Token = 2:J0|2:A0|
Consumed Token = 1:J0|1:A0|1:J1|
Token passed from J1 = 2:J0|2:A0|2:J1|[using Rule 2.b.]
From J1 to S0
Incoming Token = 2:J0|2:A0|2:J1|
Token passed from S0 = 2:J0|2:A0|2:J1|2:S0|[using Rule 4]
From S0 to A1
Incoming Token = 2:J0|2:A0|2:J1|2:S0|
Token passed from A1 = 2:J0|2:A0|2:J1|2:S0|1:A1|[using Rule 5]
From A1 to S1
Incoming Token = 2:J0|2:A0|2:J1|2:S0|1:A1|
Token passed from S1 = 2:J0|2:A0|2:J1|2:S0|1:A1|1:S1|[using Rule 4]
From S1 to J1
Incoming Token = 2:J0|2:A0|2:J1|2:S0|1:A1|1:S1|
Consumed Token = 2:J0|2:A0|2:J1|
Token passed from J1 = 2:J0|2:A0|3:J1|[using Rule 3]
From J1 to S0
Incoming Token = 2:J0|2:A0|3:J1|
Token passed from S0 = 2:J0|2:A0|3:J1|3:S0|[using Rule 4.]
From S0 to J0
Incoming Token = 2:J0|2:A0|3:J1|3:S0|
Consumed Token = 2:J0|
Token Passed from J0 = 3:J0|[using Rule 3]
From J0 to A0
Incoming Token = 3:J0|
Token Passed from A0 = 3:J0|3:A0|[using Rule 4.]
From A0 to J1
Incoming Token = 3:J0|3:A0|
Consumed Token = 2:J0|2:A0|3:J1|
Token passed from J1 = 3:J0|3:A0|4:J1|[using Rule 2.b.]
From J1 to S0
Incoming Token = 3:J0|3:A0|4:J1|
Token passed from S0 = 3:J0|3:A0|4:J1|4:S0|[using Rule 4.]
From S0 to A1
Incoming Token = 3:J0|3:A0|4:J1|4:S0|
Token passed from A1 = 3:J0|3:A0|4:J1|4:S0|2:A1|[using Rule 4.]
From A1 to S1
Incoming Token = 3:J0|3:A0|4:J1|4:S0|2:A1|
Token passed from S1 = 3:J0|3:A0|4:J1|4:S0|2:A1|2:S1|[using Rule 4.]
From S1 to END
FLOW IS TERMINATED

1. A method of controlling flow of work through a process represented by nodes, the method comprising:
generating a token for a piece of work to be performed in accordance with the process;
selectively incrementing a token value as the work flows through nodes of the process;
adding a node id to a token as it passes through the node; and
consuming tokens at selected nodes.

2. The method of claim 1 and further comprising storing the last token generated.

3. The method of claim 1 and further comprising sending a token to a next node.

4. The method of claim 1 and further comprising comparing tokens to find a maximum token value.

5. The method of claim 1 wherein consuming a token comprises:
finding an id in a token matching the id of the node;
deleting the remainder of the token following the matching id; and
incrementing a value associated with the id.

6. The method of claim 5 and further comprising sending the consumed token to the next node.

7. A method of managing tokens at a join node, the method comprising:
receiving an incoming token stream;
generating a token based on a last consumed token; and
appending a maximum of the incoming token stream and the last consumed token.

8. A method of managing tokens at a join node, the method comprising:
receiving an number “n” of incoming tokens;
identifying a first maximum of the incoming tokens;
generating a token based on a last consumed token;
identifying a second maximum of the first maximum and the last consumed token; and
appending a third maximum of the second maximum and the generated token.

9. A method of managing tokens by a join node from a loop back edge, the method comprising:
receiving an incoming token stream;
generating a token based on a last consumed token;
consuming the incoming token based on a join node id;
identifying a maximum between the consumed token and the last consumed token; and
appending the maximum and the generated token.

10. A method of determining a maximum value of two workflow tokens, one of which is an incoming token, wherein the tokens identify a path of work through a process having multiple nodes, the method comprising:
identifying a substring from each token such that all identified nodes in both tokens are equal;
comparing the substrings sequentially using the value associated with each node from each substring to find the maximum; and
modifying the incoming token to be the maximum.

11. The method of claim 10 and further comprising arbitrarily selecting a token as the maximum token when corresponding values at each node are equal.

12. The method of claim 10 wherein three or more tokens are compared.

13. A workflow engine comprising:
a token representing a path that work follows through a process;
a construct module that modifies tokens corresponding to the work; and
an activity module in the path that receives and forwards the tokens as work is being performed in the process.

14. The workflow engine of claim 13 wherein the construct module is a join or split module.

15. The workflow engine of claim 13 wherein the token comprises a value and a construct or activity id.

16. A workflow engine comprising:
means for generating a token for a piece of work to be performed in accordance with a process;
means for selectively incrementing a token value as work flows through nodes of the process;
means for adding a node id to a token as it passes through the node; and
means for consuming tokens at selected nodes.

17. A workflow engine comprising:
a processor;
a memory having a workflow program for executing on the processor;
means for inputting status of workflow; and
multiple tokens representing paths that work follows through multiple nodes of a process, wherein the program has a first module that manages tokens based on a node type, and the path taken by a token coming into the node modifies tokens corresponding to the work.

18. The workflow engine of claim 17 wherein a token comprises at least one value and id corresponding to a node.

19. The workflow engine of claim 18 wherein the value corresponding to the node represents the number of times that the token as passed through the node.

20. A computer readable medium having a token for use in managing workflow by a workflow engine, the token comprising:
node ids, representing nodes work has progressed through; and
token values corresponding to the node ids representing the number of times the work has passed through the node.

21. A method of managing a workflow token in a join node, the method comprising:
generating a token;
storing previous token values;
adding a unique join id to a token; and
consuming tokens.

22. A method of managing a workflow token in a split node, the method comprising:
generating a token;
storing previous token values; and
adding a unique split id to a token; and
consuming tokens.

23. A method of controlling workflow using tokens that identify paths taken by work progressing through a process comprising multiple nodes, the method comprising:
receiving a token having a value and id corresponding to a previous node;
using the value and id to modify the token based on the paths; and
sending the token to a further node based on the path taken by the work.

24. The method of claim 23 wherein the token is sent to a further node based on a condition separate from the token.

25. A computer readable medium having instruction for causing a computer to execute a method of controlling flow of work through a process represented by nodes, the method comprising:
generating a token for a piece of work to be performed in accordance with the process;
selectively incrementing a token value as the work flows through nodes of the process;
adding a node id to a token as it passes through the node; and
consuming tokens at selected nodes.

26. The computer readable medium of claim 25 wherein the method further comprises storing the last token generated.

27. The computer readable medium of claim 25 wherein the method further comprises sending a token to a next node.

28. The computer readable medium of claim 25 wherein the method further comprises comparing tokens to find a maximum token value.

29. The computer readable medium of claim 25 wherein consuming a token comprises:
finding an id in a token matching the id of the node;
deleting the remainder of the token following the matching id; and
incrementing a value associated with the id.

30. The computer readable medium of claim 29 wherein the method further comprises sending the consumed token to the next node.

31. A computer readable medium having instruction for causing a computer to execute a method of managing tokens at a join node, the method comprising:
receiving an incoming token stream;
generating a token based on a last consumed token; and
appending a maximum of the incoming token stream and the last consumed token.

32. A computer readable medium having instruction for causing a computer to execute a method of managing tokens at a join node, the method comprising:
receiving an number “n” of incoming tokens;
identifying a first maximum of the incoming tokens;
generating a token based on a last consumed token;
identifying a second maximum of the first maximum and the last consumed token; and
appending a third maximum of the second maximum and the generated token.

33. A computer readable medium having instruction for causing a computer to execute a method of managing tokens by a join node from a loop back edge, the method comprising:
receiving an incoming token stream;
generating a token based on a last consumed token;
consuming the incoming token based on a join node id;
identifying a maximum between the consumed token and the last consumed token; and
appending the maximum and the generated token.

34. A computer readable medium having instruction for causing a computer to execute a method of determining a maximum value of two workflow tokens, one of which is an incoming token, wherein the tokens identify a path of work through a process having multiple nodes, the method comprising:
identifying a substring from each token such that all identified nodes in both tokens are equal;
comparing the substrings sequentially using the value associated with each node from each substring to find the maximum; and
modifying the incoming token to be the maximum.

35. The computer readable medium of claim 34 wherein the method further comprises arbitrarily selecting a token as the maximum token when corresponding values at each node are equal.

36. The computer readable medium of claim 24 wherein three or more tokens are compared.

37. A computer readable medium having instruction for causing a computer to execute a method of managing a workflow token in a join node, the method comprising:
generating a token;
storing previous token values;
adding a unique join id to a token; and
consuming tokens.

38. A computer readable medium having instruction for causing a computer to execute a method of managing a workflow token in a split node, the method comprising:
generating a token;
storing previous token values; and
adding a unique split id to a token; and
consuming tokens.

39. A computer readable medium having instruction for causing a computer to execute a method of controlling workflow using tokens that identify paths taken by work progressing through a process comprising multiple nodes, the method comprising:
receiving a token having a value and id corresponding to a previous node;
using the value and id to modify the token based on the paths; and
sending the token to a further node based on the path taken by the work.

40. The computer readable medium of claim 17 wherein the token is sent to a further node based on a condition separate from the token.
